(19) United States
(12) Patent Application Publication
(10) Pub. No.: US 2026/0362133 A1
(43) Pub. Date: Nov. 12, 2026

(54) SYSTEMS AND METHODS FOR AUTHENTICATION BASED ON A SUBSCRIBER IDENTITY MODULE

(71) Applicant: Infobip Ltd., London (GB)

(72) Inventors: Kwok Onn LOOI, Puchong (MY); Filip CIMERMANCIC, Zagreb (HR); Damir MILOTIC, Zagreb (HR)

(73) Assignee: Infobip Ltd., London (GB)

(21) Appl. No.: 19/202,255

(22) Filed: May 8, 2025

(51) Int. Cl. H04W 12/06; H04W 8/18

(52) U.S. Cl. CPC H04W 12/06; H04W 8/18

(57) ABSTRACT

A method may include receiving a first authentication request associated with a user device and including an MSISDN and a first IMSI, wherein the first authentication request represents a request for authentication information; determining a network based on the first IMSI; transmitting a second authentication request, wherein the second authentication request includes the MSISDN and the first IMSI; receiving a second IMSI and the authentication information, wherein the authentication information includes at least a random network challenge and a first SRES; determining whether the first IMSI matches the second IMSI; in response to determining that the first IMSI matches the second IMSI, transmitting the random network challenge of the authentication information; receiving a second SRES based on the transmitted random network challenge; determining whether the first SRES matches the second SRES; and transmitting the determination of whether the first SRES matches the second SRES.

### TECHNICAL FIELD

Various embodiments of the present disclosure relate generally to systems and methods for authentication based on a subscriber identity module (“SIM”), and more particularly, to systems and methods for authenticating a user of a mobile device based on a SIM card and a Mobile Station International Subscriber Directory Number (“MSISDN”) that are associated with the mobile device.

### BACKGROUND

Many applications such as messaging applications, social media applications, financial applications, or the like, require users to register with the applications, such as where the users are first-time users of the applications. For example, an application operating on a mobile device may require a user, who uses the mobile device, to register with the application by creating an account associated with the application. During this registration process, the user may use the mobile device to enter a MSISDN (e.g., a phone number), which the application may use to identify the user. The application may subsequently cause a one-time password (“OTP”) to be transmitted to the mobile device, and the application may prompt the user to supply the one-time password to the application in order to complete the registration process and/or authenticate the user.

Unfortunately, in some cases, the user may be a fraudster or other bad actor who improperly obtained the MSISDN (e.g., using a service provided on the dark web). In such cases, the account created by the fraudster may represent a fake account through which the fraudster may transmit malicious messages to other people, or commit fraud or other crimes. In some aspects, the creation of such an account may be referred to as phone verified account (“PVA”) fraud. Accordingly, many applications that use MSISDNs to register and/or authenticate users are vulnerable to being used for wrongful purposes by fraudsters.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

A method may comprise receiving, by a computing system, a first authentication request from a server, wherein the first authentication request is associated with a user device and includes a Mobile Station International Subscriber Directory Number (MSISDN) and a first International Mobile Subscriber Identity (IMSI), and wherein the first authentication request represents a request for authentication information; determining, by the computing system, a network based on the first IMSI; transmitting, by the computing system, a second authentication request to the network, wherein the second authentication request includes the MSISDN and the first IMSI; receiving, by the computing system and from the network, a second IMSI and the authentication information, wherein the authentication information includes at least a random network challenge and a first Signed Response (SRES); determining, by the computing system, whether the first IMSI matches the second IMSI; in response to determining that the first IMSI matches the second IMSI, transmitting, by the computing system, the random network challenge of the authentication information to the server; receiving, by the computing system, a second SRES from the server based on the transmitted random network challenge; determining, by the computing system, whether the first SRES matches the second SRES; and transmitting, by the computing system, the determination of whether the first SRES matches the second SRES to the server.

A method may comprise receiving, by a computing system, a first request from a server, wherein the first request is associated with a user device and includes a Mobile Station International Subscriber Directory Number (MSISDN), an AKMA Key Identifier (A-KID), and an Application Function Identifier; determining, by the computing system, a network based on the A-KID; transmitting, by the computing system, a second request to the network, wherein the second request includes the A-KID and the Application Function Identifier; receiving, by the computing system and from the network, a Generic Public Subscription Identifier (GPSI) and an Authentication and Key Management for Applications (AKMA) application key; determining, by the computing system, whether the MSISDN matches a value of the GPSI; and transmitting, by the computing system, the determination of whether the MSISDN matches the value of the GPSI to the server.

A method may comprise receiving, by a computing system, a first request from a first server, wherein the first request is associated with a user device and includes a first Mobile Station International Subscriber Directory Number (MSISDN), and wherein the first request represents a request for an Access Token; determining, by the computing system, a second server based on the MSISDN; generating, by the computing system, the Access Token subsequent to determining, and being in communication with, the second server; transmitting, by the computing system and to the first server, the Access Token and a uniform resource locator associated with the second server; subsequent to transmitting the Access Token, receiving, by the computing system and from the first server, an Operator Token; transmitting, by the computing system and using the Operator Token, a second request to the second server, wherein the second request represents a request for information associated with the user device; receiving, by the computing system, a second MSISDN from the second server, based on the second request; determining, by the computing system, whether the first MSISDN matches the second MSISDN; and transmitting, by the computing system and to the first server, the determination of whether the first MSISDN matches the second MSISDN.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts information regarding various channels that may be used by application(s) configured to perform MSISDN-based authentication, according to one or more embodiments.

FIG. 2 depicts a block diagram of a computing environment, according to one or more embodiments.

FIG. 3 depicts a SIM-based authentication process, according to one or more embodiments.

FIG. 4 depicts another SIM-based authentication process, according to one or more embodiments.

FIG. 5 depicts another SIM-based authentication process, according to one or more embodiments.

FIG. 6 depicts a flow diagram of a method for SIM-based authentication, according to one or more embodiments.

FIG. 7 depicts a flow diagram of another method for SIM-based authentication, according to one or more embodiments.

FIG. 8 depicts a flow diagram of another method for SIM-based authentication, according to one or more embodiments.

FIG. 9 depicts a TS.43-based process for authentication, according to one or more embodiments.

FIG. 10 depicts another TS.43-based process for authentication, according to one or more embodiments.

FIG. 11 depicts a TS.43-based process for obtaining device information, according to one or more embodiments.

FIG. 12A illustrates an architecture of a computing system, according to one or more embodiments.

FIG. 12B is a block diagram of a computing system, according to one or more embodiments.

### DETAILED DESCRIPTION OF EMBODIMENTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Many applications require users to register with the applications. For example, a user may wish to register with an application (e.g., a payment application, a shopping application, a transportation application, a messaging application, a social media application, or the like) recently installed on the user's mobile device. During the registration process, the application may prompt the user to supply information such as the user's name, email address, user identification (“ID”), and/or MSISDN, to create an account and identify the user. In some embodiments, the MSISDN may represent a phone number that is associated with the user's mobile device. In some aspects, the user may subscribe to a mobile service provided by a Mobile Network Operator (“MNO”) (e.g., Verizon, T-Mobile, AT&T, or the like), where the MNO assigns the MSISDN to a SIM card inserted in the user's mobile device or to an embedded SIM (“eSIM”) card. It will be understood that a “SIM card” as referenced herein may refer to a physical SIM card, an eSIM card, or any other applicable SIM component. In some aspects, the MSISDN may represent an asset of the MNO. As used herein, an MNO may also be referred to as a “carrier.”

Where the application receives the MSISDN during the registration process, the application may use the MSISDN to authenticate the user for use of the application and/or to complete the registration process. That is, the application may cause a one-time password or code to be transmitted via a channel to the user's mobile device, and the application may prompt the user to enter the one-time password or code in order to verify the identity of the user (e.g., to complete the registration process, to use the application, etc.)—and, as further described herein, to verify that the user is in possession of the MSISDN or the SIM hosting the MSISDN.

As used herein, a process for authenticating a user of a mobile device using an MSISDN may also be referred to as “MSISDN-based authentication” or an “MSISDN-based authentication process.” In some aspects, given the ubiquity of mobile devices today, MSISDN-based authentication is often used by applications to register, enroll, or onboard new users of the applications.

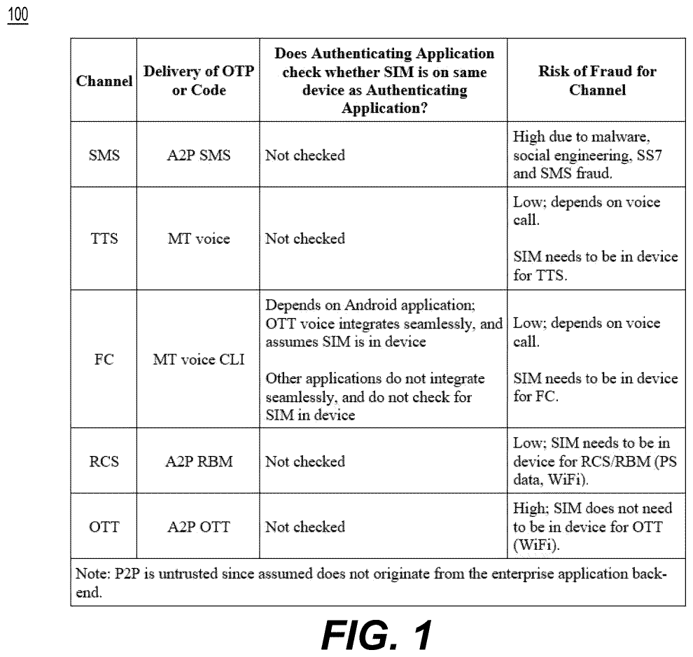

FIG. 1 depicts information 100 regarding various channels that may be used by application(s) configured to perform MSISDN-based authentication (where such application(s) may also be referred to herein as “authentication application(s)”), according to one or more embodiments. More specifically, the information 100 describes (i) various channels that may be used by authentication application(s) for MSISDN-based authentication, (ii) how the channels may be used to deliver a one-time password or code to a mobile device, (iii) whether the authentication application(s) check whether a SIM card to which the MSISDN is assigned is installed in the mobile device, and (iv) the risk of fraud associated with each channel.

As shown in FIG. 1, in some embodiments, an authentication application may use a Short Message Service (“SMS”) as a channel to deliver a one-time password or code to a mobile device. That is, the one-time password or code may be delivered to the mobile device as an application-to-person (“A2P”) SMS. In such embodiments, the authentication application may not check whether the mobile device includes a SIM card that is associated with (or hosts) the MSISDN used to deliver the SMS containing the one-time password or code (or whether the SIM card is on the same device as the authentication application). In such embodiments, the risk of fraud associated with the SMS channel may be high because of the following: (i) the OTP delivered via SMS may be stolen via social engineering or phishing fraud, (ii) the OTP delivered via SMS may be intercepted with known System Signaling 7 (“SS7”) exploit or signaling vulnerabilities, (iii) malware known to be spread using SMS via malicious URLs, and/or (iv) exposure to SMS fraud such as PVA, artificially inflated traffic (“AIT”), or spam.

Further, in some embodiments, an authentication application may use a Text-to-Speech (“TTS'”) call as a channel to deliver a one-time password or code to a mobile device. That is, the one-time password or code may be delivered to the mobile device as mobile-terminated (“MT”) voice of the TTS call. In such embodiments, the authentication application may not check whether the mobile device includes a SIM card that is associated with the MSISDN used to deliver the TTS call containing the one-time password or code (or whether the SIM card is on the same device as the authentication application). In such embodiments, the risk of fraud associated with the TTS channel may be low since a known vulnerability such as intercepting the TTS call may require a sophisticated signaling exploit to compromise the TTS call. An example of such a sophisticated signaling exploit is a call forwarding exploit, where a fraudster illegally forwards a TTS call to a victim's MSISDN, to the fraudster's own phone number. In some aspects, a SIM card associated with an MSISDN used to deliver a one-time password or code via a TTS call needs to be installed in a mobile device in order for the mobile device to receive the TTS voice call.

In some embodiments, an authentication application may use a flash call (“FC”) as a channel for delivering a one-time password or code to a mobile device. That is, the one-time password or code may be delivered to the mobile device within the mobile-terminated voice calling line identification (“CLI”) of the flash call. In such embodiments, where the authentication application represents a mobile platform application, the authentication application may check whether the mobile device includes a SIM card that is associated with the MSISDN used to deliver the flash call containing the one-time password or code within the CLI (or whether the SIM card is on the same device as the authentication application). Where the authentication application represents a mobile platform application such as an Over-the-Top voice application or an application that has been assigned the privilege to check the received call log(s) of the mobile device (e.g., an Android device), the application may be configured to (i) seamlessly retrieve the received flash call CLI containing the one-time password or code from the received call log(s), and (ii) read and analyze (or verify) the one-time password or code to authenticate a user of the mobile device. The authentication application may assume that the mobile device includes a SIM card that is associated with the MSISDN to receive the flash call.

Where the authentication application represents a non-mobile platform specific application operating on the mobile device (e.g., a non-Android device), or an application that does not have the privilege to check the received call log(s) of the mobile device (e.g., a non-OTT voice such as payment application), the authentication application may not seamlessly retrieve the received flash call CLI from the received call log(s), but rather require the user to manually retrieve the delivered one-time-password or code from the flash call CLI in the received call log(s), and to then supply the one-time-password or code to the authentication application. In such embodiments (e.g., where the authentication application uses a flash call), the risk of fraud associated with the flash call channel may be low since a known vulnerability such as intercepting the flash call may require a sophisticated signaling exploit (e.g., a call forwarding exploit) to compromise the flash call. Further, the SIM card associated with the MSISDN used to deliver the one-time password or code via the flash call needs to be installed in the mobile device in order for the mobile device to receive the flash call.

As shown in FIG. 1, in some embodiments, an authentication application may use Rich Communication Services (“RCS′”) as a channel to deliver a one-time password or code to a mobile device. Put differently, the one-time password or code may be delivered to the mobile device as an application-to-person RCS business message (“RBM”). In such embodiments, the authentication application may not check whether the mobile device includes a SIM card that is associated with the MSISDN used to deliver the RCS/RBM containing the one-time password or code (or whether the SIM card is on the same device as the authentication application). In such embodiments, the risk of fraud associated with the RCS channel may be low given that the SIM needs to be in the mobile device in order for the mobile device to receive the one-time password or code via RCS (e.g., as an RBM). In some aspects, the one-time password or code may be transmitted to the mobile device via RCS and using packet-switched data (“PS”) transmission or Wi-Fi.

In some embodiments, an authentication application may use Over-the-Top as a channel for delivering a one-time password or code to a mobile device. That is, the one-time password or code may be delivered to the mobile device as an application-to-person OTT message. In such embodiments, the authentication application may not check whether the mobile device includes a SIM card that is associated with the MSISDN used to deliver the OTT message containing the one-time password or code (or whether the SIM card is on the same device as the authentication application). In such embodiments, the risk of fraud associated with the OTT channel may be high given that the SIM does not need to be in the mobile device in order for the mobile device to receive the one-time password or code via OTT messaging (e.g., using Wi-Fi).

As indicated in FIG. 1, authentication application(s) may not use peer-to-peer (“P2P”) transmission as a channel for MSISDN-based authentication since it may be assumed that the one-time password or code would originate (or be transmitted) from an untrusted peer, as opposed to a trusted enterprise application back-end server or service provider.

Accordingly, as shown in FIG. 1, many MSISDN-based authentication processes used by authentication applications assume that (but do not check whether) a user is in possession of a mobile device that includes a SIM card associated with an MSISDN that the authentication applications use to authenticate the user. Further, many MSISDN-based authentication processes used by authentication applications do not require or mandate that the user be in possession of a mobile device that includes a SIM card associated with an MSISDN used by the authentication applications to authenticate the user. As a result, such MSISDN-based authentication processes used by authentication applications may authenticate a user in possession of a mobile device that does not include a SIM card associated with an MSISDN used to authenticate the user (e.g., because the SIM card was intentionally or unintentionally removed from the mobile device, or because the user is a fraudster who obtained the delivered one-time-password or code through unlawful means). Further, such MSISDN-based authentication processes may contravene an expected Level of Assurance (“LOA”) (e.g., an expected degree of confidence regarding a user's identity) associated with the authentication applications that employ these MSISDN-based authentication processes. Moreover, in some cases, authentication applications may deploy such MSISDN-based authentication processes only when users are being registered (or enrolled or onboarded) for the authentication applications, and as a result, the users may continue to use these authentication applications on mobile devices that do not include SIM cards that host the MSISDNs used to initially register and/or authenticate the users. Accordingly, such authentication applications—and especially those that are associated with banking, finance, or eWallets (involving, for example, payments, digital identity, license(s), certificate(s), or credential(s)), eHealth applications, OTT applications (or applications that are associated with, based on, or use OTT), applications not associated with or not based on an operating system, and applications not provided or not developed by MNOs or carriers—include a security loophole and are vulnerable to be exploited by fraudsters. For instance, a payment application that includes an authentication application that uses MSISDN-based authentication but does not require that a user's mobile device include a SIM card that hosts an MSISDN used to authenticate the user, may allow the user to make fraudulent digital fund transfers, or to fraudulently receive digital funds, due to the security loophole.

Thus, to close the security loophole, aspects of the present disclosure describe MSISDN-based authentication methods that bind authentication applications (e.g., third-party authentication applications but not operating system applications, MNO applications, or carrier applications) to SIM cards in order to provide more robust authentication of users who use the authentication applications on mobile devices, and to ensure that MSISDNs used to identify such users are hosted or otherwise associated with SIM cards of these mobile devices. Put differently, such MSISDN-based authentication methods ensure that an MSISDN used to authenticate a user to use a certain third-party application (that includes an authentication application) on a mobile device, is actually in the possession of the user (e.g., via a SIM card inserted in or associated with the mobile device). In some aspects, such an MSISDN-based authentication method may use an MSISDN to identify a user while the user uses an authentication application that employs the MSISDN-based authentication method.

As explained above, an authentication application that uses (or integrates with) an MSISDN-based authentication method that binds the authentication application to a SIM card of a user's device may represent a third-party application, and may also be referred to herein as a “third-party application.” Such a third-party application is distinct from an application that (i) is provided by operating system vendor or MNO, and/or (ii) has special access privileges to the SIM card on the user's device. In some aspects, an MSISDN-based authentication method that binds a third-party application to a SIM of a user's mobile device may also be referred to herein as a “SIM-based authentication method” or “SIM-based authentication process.” Further, in some aspects, the third-party application may be provided or offered by an enterprise, brand, or other entity for a wide variety of purposes. For example, the third-party application may represent a digital wallet, a payment application, or a telco messaging application, that relies on an MSISDN to identify a user of the third-party application. Moreover, such a third-party application may provide a trusted channel to deliver a one-time password or code to a user's device in order to authenticate the user, thereby increasing the security of the channel (or reducing or eliminating the risk of fraud associated with the channel).

As explained above (and as discussed further herein), the third-party application may bind or integrate with the SIM card of a user's mobile device when SIM-based authentication is performed. When the SIM-based authentication is successfully completed, the third-party application is assured that the SIM card is present and active in the user's mobile device, and that the MSISDN used to authenticate the user is active and associated with the SIM card. In some aspects, the SIM-based authentication methods described herein may leverage on the primary authentication performed using a mobile device and an MNO that provides a mobile service via the mobile device (also referred to herein as a “home MNO”), in accordance with procedures such as Extensible Authentication Protocol-Authentication and Key Agreement (“EAP-AKA”) or Fifth Generation-Authentication and Key Agreement (“5G-AKA”). In some aspects, the SIM-based authentication methods described herein may be performed using packet-switched transmission (or packet data) or Wi-Fi, and thus require internet connectivity. Further, a SIM-based authentication method of the present disclosure may be performed when a third-party application is first run, is re-started, and/or when there are one or more changes to the connection state of a mobile device (e.g., the mobile device is reconnected to the internet, the mobile device transitions from supporting a mobile service of one MNO to another MNO), when there are one or more changes to the state of a SIM card in a mobile device, or when the third-party application deems it necessary to re-run the SIM-based authentication method.

In some aspects, because the SIM-based authentication methods discussed herein may be used by a relatively large number of third-party applications (including third-party application backend services), and involve integration with MNOs, potentially worldwide, an aggregator (e.g., aggregation system, aggregation entity, aggregation component, and/or the like) may be used to integrate the third-party applications with the MNOs (e.g., globally or in the markets of the third-party applications). The aggregator may be especially useful for an owner or operator of a third-party application that integrates a SIM-based authentication method with the third party application, without directly integrating with one or more MNOs. Accordingly, an aggregator, as discussed herein, may facilitate implementation of SIM-based authentication methods without direct communication or interaction between an application and one or more MNOs. Such implementations may reduce the number of connections between various third-party applications and MNOs, by using a centralized aggregator and resulting in time and computing resource efficiency. The aggregator may also benefit MNOs who wish to support SIM-based authentication methods performed on mobile devices for a variety of third-party applications, but only for mobile devices of users who are subscribers of the respective MNOs. Accordingly, the aggregator may serve as a partner of, and intermediary between, third-party applications and MNOs, and may enable SIM-based authentication methods, as further discussed herein. As a result, third-party applications and MNOs do not need to directly integrate or directly communicate with one another, and instead may communicate with one another using the aggregator as a single point of contact. Thus, the aggregator may help third-party applications and MNOs integrate and enable SIM-based authentication methods in many different markets or regions (e.g., local, regional, or global markets or regions) in order to achieve the minimum required market coverage for sustainable and successful service. However, it will be understood that the techniques disclosed herein are not limited to the examples provided above.

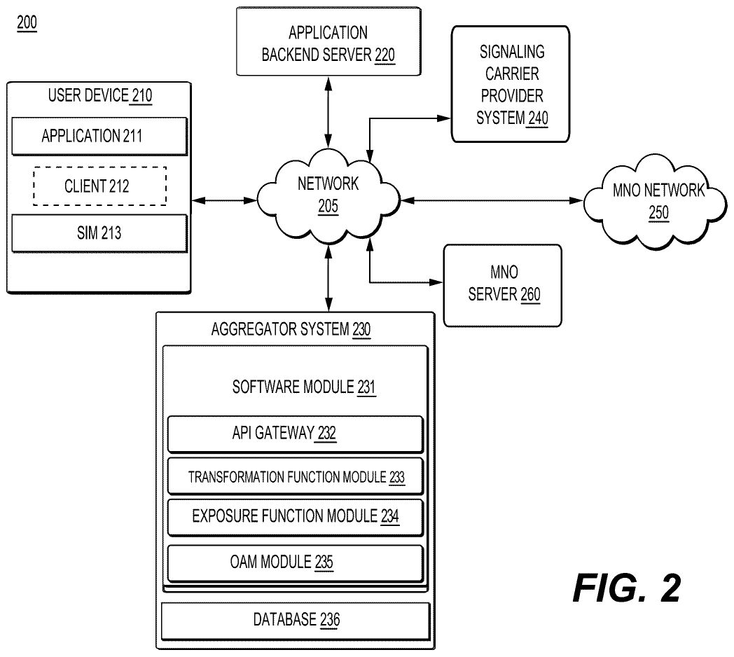

FIG. 2 is a block diagram of a computing environment 200, according to example embodiments. In some aspects, the computing environment 200 may be configured to support one or more SIM-based authentication methods, as described herein. As shown in FIG. 2, the computing environment 200 may include a user device 210, an application backend server 220, an aggregator system 230, a signaling carrier provider system 240, an MNO network 250, and/or an MNO server 260, where each of these one or more components communicates via a network 205. It will be understood that although components of the computing environment 200 are shown separately, one or more components may be integrated with each other (e.g., as a single component) and/or may communicate directly with each other. Further, in some embodiments, the computing environment 200 may include multiple user devices 210, application backend servers 220, aggregator systems 230, signaling carrier provider systems 240, MNO networks 250, and/or MNO servers 260.

The network 205 may be of any suitable type, including individual connections via the Internet, such as cellular or Wi-Fi networks. In some embodiments, the network 205 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Further, the network 205 may include any type of computer or telecommunication networking arrangement used to exchange data or information. For example, the network 205 may be the Internet, a private data network, virtual private network using a public network, mobile signaling network, and/or other suitable connection(s) that enables components of the computing environment 200 to send and receive information between components of the computing environment 200.

The user device 210 may represent a mobile device (e.g., a smartphone, tablet, or wearable device) by which an associated user may access and/or interact with other systems in the computing environment 200. In some aspects, the user associated with the user device 210 may subscribe to mobile services provided by the MNO network 250 and/or the MNO server 260, and access the mobile services through the user device 210.

As shown in FIG. 2, the user device 210 may include an application 211, a SIM 213, and optionally a client 212. In some aspects, the application 211 may represent a third-party application (e.g., an application configured to employ or integrate with a SIM-based authentication method). The client 212 may represent a TS.43 client (e.g., an application associated with the TS.43 Technical Specification), and/or an application configured to communicate with a Service Entitlement Configuration Server (e.g., the MNO server 260). In some aspects, the client 212 may represent a set of software libraries within an operation system (e.g., an Android or iOS operating system) of the user device 210. Further, the client 212 may be accessed by the operating system of the user device 210 or by the application 211 using necessary privileges such as carrier privileges signed with the same certificate that is included in the SIM 213. In some aspects, the client 212 may interwork with the SIM 213 (e.g., a SIM card or embedded SIM (“eSIM”)) on the user device 210. Further, the client 212 may support one or more services within the scope of TS.43, such as Voice over Cellular (e.g., 4G Voice-over-LTE (“VoLTE”) or 5G Voice-over-New-Radio (“VoNR”), Voice over Wi-Fi (VoWIFI), SMS over internet protocol (“IP”) (“SMSoIP”), On-Device Service Activation (ODSA) (e.g., for the user device 210), data plans, direct barrier billing, private user identity (e.g., for SIM-based authentication using EAP for Access points), Device and User Information, Application Authentication or Satellite Mode (“SatMode”).

The SIM 213 may represent a SIM card that may be installed on the user device 210, or an eSIM incorporated in the user device 210. In some aspects, the SIM 213 may be used to authenticate a user associated with the user device 210, and to connect the user device 210 to the network 205, the signaling carrier provider system 240, the MNO network 250, and/or the MNO server 260. Further, in some aspects, the SIM 213 may be assigned (or associated with) an MSISDN (e.g., a phone number) by the MNO network 250 and/or the MNO server 260. In some embodiments, the SIM 213 may store the MSISDN. Further, the SIM 213 may store an International Mobile Subscriber Identity (“IMSI”), which may represent a unique identifier assigned to the SIM 213, by the MNO network 250 and/or the MNO server 260.

The application backend server 220 may represent one or more server systems or other computing devices associated with, for example, an organization, company, or other entity. In some aspects, the application backend server 220 may be configured to interact with other systems of the computing environment 200. Further, the application backend server 220 may be configured to generate, transmit, or facilitate the operation of, one or more third-party applications (e.g., third-party applications that use or integrate with SIM-based authentication methods).

The aggregator system 230 may represent one or more server systems or other computing devices associated with, for example, an organization, company, or other entity. In some aspects, the aggregator system 230 may be configured to interact with other systems of the computing environment 200. For example, the aggregator system 230 may be configured to act as an intermediary between (i) the application backend server 220 and (ii) one or more of the signaling carrier provider system 240, the MNO network 250, and/or the MNO server 260. Further, the aggregator system 230 may be configured to provide or enable one or more SIM-based authentication methods, as further described herein. As shown in FIG. 2, the aggregator system 230 may include a software module 231 and a database 236. In some embodiments, the aggregator system 230 may represent or include a Communications Platform as a Service (“CPaaS”) to support the functions and capabilities of the software module 231 and the database 236. As shown in FIG. 2, the software module 231 may include an application programming interface (“API”) gateway 232, a transformation function module 233, an exposure function module 234, and an operations, administration, and management (“OAM”) module 235.

In some embodiments, the API gateway 232 may be configured to interwork with the application backend server 220 over a defined API. Further, the API gateway 232 may act as an intermediary (e.g., an abstracted connection) between (i) the application backend server 220 and (ii) one or more of the signaling carrier provider system 240, the MNO network 250, and/or the MNO server 260. According to some embodiments, an Exposure Function Module 234 may also act as an intermediary (e.g. an abstracted connection) between (i) the application backend server 220 and (ii) one or more of the signaling carrier provider system 240, the MNO network 250, and/or the MNO server 260. In some aspects, the API gateway 232 may route requests, transform protocols, aggregate data, and enforce security policies.

The transformation function module 233 may be configured to perform a transformation function. For example, the transformation function module 233 may be configured to map (i) transactions between the aggregator system 230 and the application backend server 220 to (ii) transactions between the aggregator system 230 and one or more of the signaling carrier provider system 240, the MNO network 250, and/or the MNO server 260. The transformation function module 233 may also be configured to transform and/or rationalize data and/or parameters associated with communications between (i) the aggregator system 230 and the application backend server 20, and (ii) the aggregator system 230 and one or more of the signaling carrier provider system 240, the MNO network 250, and/or the MNO server 260.

The exposure function module 234 may be configured to perform an exposure function. For example, the exposure function module 234 may be configured to securely and efficiently expose one or more services or resources (e.g., associated with the aggregator system 230) to one or more of the signaling carrier provider system 240, the MNO network 250, and/or the MNO server 260. Further, the exposure function module 234 may be configured to integrate with resources of one or more of the signaling carrier provider system 240, the MNO network 250, and/or the MNO server 260, over the supported network interfaces.

The OAM module 235 may be configured to facilitate operations, administration, and management functions associated with the aggregator system 230. For example, the OAM module 235 may be configured to perform management processes, to supply administration tools, and/or to supply or facilitate standard operations associated with the aggregator system 230.

The database 236 may be configured to store user and system transactions, and/or transaction states between (i) aggregator system 230 and the application backend server 220, and/or between (ii) the aggregator system 230 and one or more of the signaling carrier provider system 240, the MNO network 250, and/or the MNO server 260.

The signaling carrier provider system 240 may represent one or more server systems or other computing devices associated with an organization, a company (e.g., a signaling carrier associated with or providing services to the MNO network 250 or the MNO server 260), or other entity. In some aspects, the signaling carrier provider system 240 may be configured to interact with other systems of the computing environment 200. For example, the signaling carrier provider system 240 may be configured to act as an intermediary between the aggregator system 230 and the MNO network 250 to transport signaling messages.

The MNO network 250 may be owned, operated, or associated with an MNO, and be configured to manage and transmit data or communications within the computing environment 200. In some aspects, the MNO network 250 may be configured to transmit, manage, or route data or communications to the signaling carrier provider system 240. Further, in some embodiments, the MNO network 250 may represent an MNO core network that operates and supports the 2G/3G, 4G LTE, 5G non-stand-alone (“NSA”) and/or 5G stand-alone (“SA”) networks.

The MNO server 260 may represent one or more server systems or other computing devices associated with an MNO. In some aspects, the MNO server 260 may represent core network nodes such as Home Location Register (HLR), Home Subscriber System (HSS) or Network Exposure Function (NEF). In some aspects, the MNO server 260 may be configured to communicate with the user device 210. Further, in some aspects, the MNO server 260 may represent an MNO Entitlement Configuration Server (“ECS”). In such embodiments, the MNO server 260 may enable a service provider (e.g., an MNO) to manage service entitlement information for a client (e.g., a user of the user device 210 who is a subscriber of the service provider). In some aspects, the MNO server 260 may be configured to carry out such management when entitlement verification is being performed and/or when a mobile service (e.g., for a user of the user device 210) is being activated. In some aspects, the MNO server 260 may be configured to support entitlement configuration using packet-switched data transmission (or packet data) or Wi-Fi, so long as the user device 210 may use the internet to access the MNO server 260. In some embodiments, entitlement configuration may be optional, and may be distinct from a mobile service configuration. Further, in some aspects, the MNO server 260 may interwork with the user device 210 and the MNO network 250 (including nodes such as the Third Generation Partnership Project (“3GPP”) Authentication, Authorization, and Accounting Security Framework (“AAA”), a Base Station Subsystem (“BSS”), and/or an Operational Support System (“OSS”)). In some embodiments, the MNO server 260 may configure the user device 210 during entitlement verification or during activation of a mobile service, in accordance with a procedure defined in the Permanent Reference Document (“PRD”) TS.43 published by the Global Systems for Mobile Communications Association (“GSMA”) (or defined in the GSMA PRD TS.43).

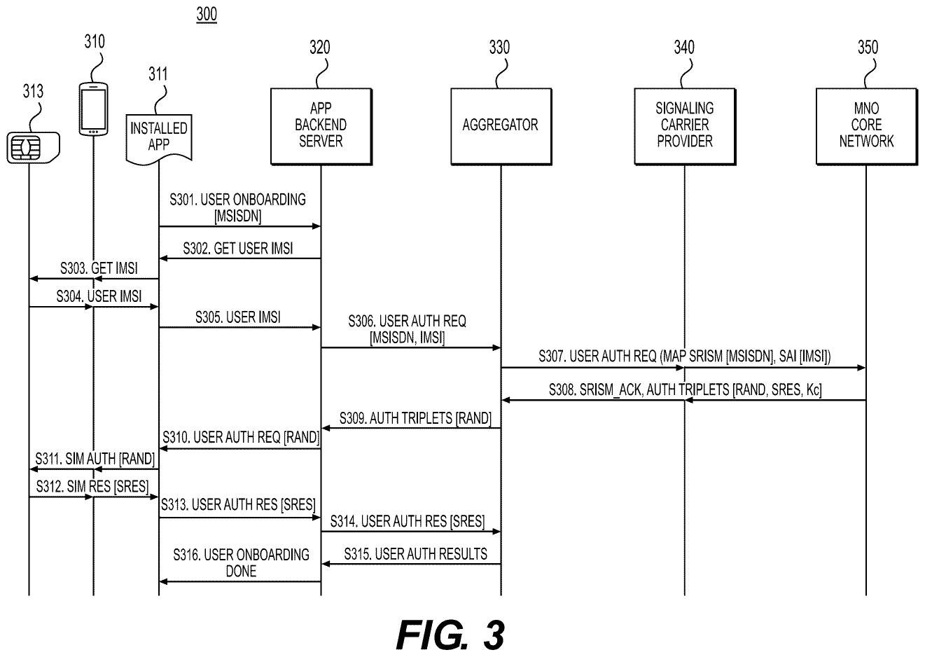

FIG. 3 depicts a SIM-based authentication process 300, according to one or more embodiments. In some aspects, the SIM-based authentication process 300 may represent a Mobile Application Part (“MAP”) SendAuthenticationInfo (“SAI”) SIM-based authentication process. As shown in FIG. 3, the SIM-based authentication process 300 may be performed using a SIM 313, a user device 310, an installed application 311, an application (or app) backend server 320, an aggregator 330, a signaling carrier provider 340, and an MNO Core Network 350. In some aspects, the SIM 313 may be an embodiment of the SIM 213; the user device 310 may be an embodiment of the user device 210; the installed application may be an embodiment of the application 211; the application backend server 320 may be an embodiment of the application backend server 220; the aggregator 330 may be an embodiment of the aggregator system 230; the signaling carrier provider 340 may be an embodiment of the signaling carrier provider system 240; and the MNO Core Network 350 may be an embodiment of the MNO network 250 in connection with the MNO Server 260.

In some aspects, the SIM-based authentication process 300 may be performed when various conditions are satisfied. For example, the SIM-based authentication process 300 may be performed when (i) the installed application 311 possesses a privilege to access the SIM 313 on the user device 310; and (ii) the aggregator 330 is integrated via the Signaling Carrier Provider 340 with the MNO Core Network 350 (e.g. a home MNO of a user associated with the SIM 313), by having signaling access to query the MAP SAI and MAP Send Routing Information for Short Message (“SRISM”) operations. In some embodiments, where the MNO Core Network 350 supports or facilitates Fourth Generation (“4G”) Long Term Evolution (“LTE”) Evolved Packet Core (“EPC), Second Generation (“2G”), Third Generation (“3G”), SS7, and/or a Circuit Switched Core Network, similar conditions must be satisfied in order for the SIM-based authentication process 300 to be performed.

As shown in FIG. 3, the SIM-based authentication process 300 may include steps S301 through S316. At S301, the user of the user device 310 installs the application (a third-party application) on the user device 310. In some aspects, the installed application may be provided by an application provider or the application backend server 320. Further, the installed application may onboard (or register) the user of the user device 310 with the application backend server 320. The installed application 311 may provide an MSISDN to the application backend server 320, or transmit a request to the application backend server 320 to reauthenticate the user of the user device 310. At S302, the application backend server 320 may request that the installed application 311 acquire the user's IMSI from the SIM 313 via the user's device 310. At S303, the installed application 311 may use necessary privileges to query the SIM 313 for the user's IMSI. At S304, the SIM 313 may respond to the installed application 311 with the user's IMSI (or IMSI value). At S305, the installed application 311 may respond to the application backend server 320 with the user's IMSI. At S306, the application backend server 320 queries the aggregator 330 (e.g., a partner aggregator) to authenticate the user with the user's home MNO by providing the user's IMSI and MSISDN to the aggregator 330. At S307, the aggregator 330 examines the prefix of the IMSI for the Mobile Country Code (“MCC”) and Mobile Network Code (“MNC”) to identify the user's MNO, and subsequently queries (via the signaling carrier provider 340) the MNO Core Network 350 (e.g., the user's MNO) with the MAP SRISM operation with the user's MSISDN, and the MAP SAI operation with the user's IMSI. At S308, the MNO Core Network 350 responds to the MAP SRISM query (via the signaling carrier provider 340) with an IMSI (or IMSI value) associated with the user's MSISDN, and to the MAP SAI query with the user's authentication triplets. The user's authentication triplets may include (i) a random challenge (“RAND”) (or random network challenge) generated by the MNO Core Network 350, (ii) a signed response (“SRES”), which is the result of an authentication algorithm applied to the RAND and a secret key similarly stored on the SIM 313, and (iii) a ciphering key (K_{c}) (or ciphering key information) used to encrypt data transmitted between the user device 310 and the MNO Core Network 350.

At S309, the aggregator 330 may determine whether the IMSI value received from the application backend server 320 matches the IMSI value received from the MNO Core Network 350. This is to verify that the user's SIM has not been changed (e.g., to verify that the provided MSISDN is actually hosted on the user's SIM with the assigned IMSI). If the IMSI value received from the application backend server 320 matches the IMSI value received from the MNO Core Network 350, the aggregator 330 responds to the application backend server 320 with the RAND information. At S310, the application backend server 320 requests the installed application 311 to authenticate the user's SIM 313 with the RAND information. At S311, the installed application 311 instructs the SIM 313 to carry out or execute a RUN GSM ALGORITHM operation with the RAND. At S312, the SIM 313 provides the results of RUN GSM ALGORITHM operation along with a generated SRES value to the installed application 311.

At S313, the installed application 311 responds to the application backend server 320 with the generated SRES value. At S314, the application backend server 320 responds to the aggregator 330 with the generated SRES value. At S315, the aggregator 330 compares the SRES value received from the application backend server 320 to the SRES value received from the MNO Core Network 350, and responds to the application backend server 320 with the results of the comparison (e.g., whether the two SRES values match) by indicating, for example, TRUE, if the SRES values match, or FALSE if the SRES values do not match. At S316, the application backend server 320 processes the results received from the aggregator 330 to determine the outcome of the user onboarding, and if the SIM-based authentication is successful. If the application backend server 320 determines that the user onboarding is complete and that the user of the user device 310 is authenticated, then the user may proceed to use the installed application 311 with the verified MSISDN and SIM. In some aspects, where the application backend server 320 determines that the SIM-based authentication is successful, this represents that MSISDN is associated with the SIM 313, which is verified to be in use in the user device 310. If the application backend server 320 determines that the user onboarding is not complete and/or that the user of the user device 310 is not authenticated, then the user may not proceed to use or access one or more functions of the installed application 311 such as to use the MSISDN with the application. Further, where the application backend server 320 determines that the SIM-based authentication is unsuccessful, this represents that MSISDN is not associated with the SIM 313; hence, the MSISDN is not verified and the installed application may refuse to accept the MSISDN as the user's identity in association with the SIM.

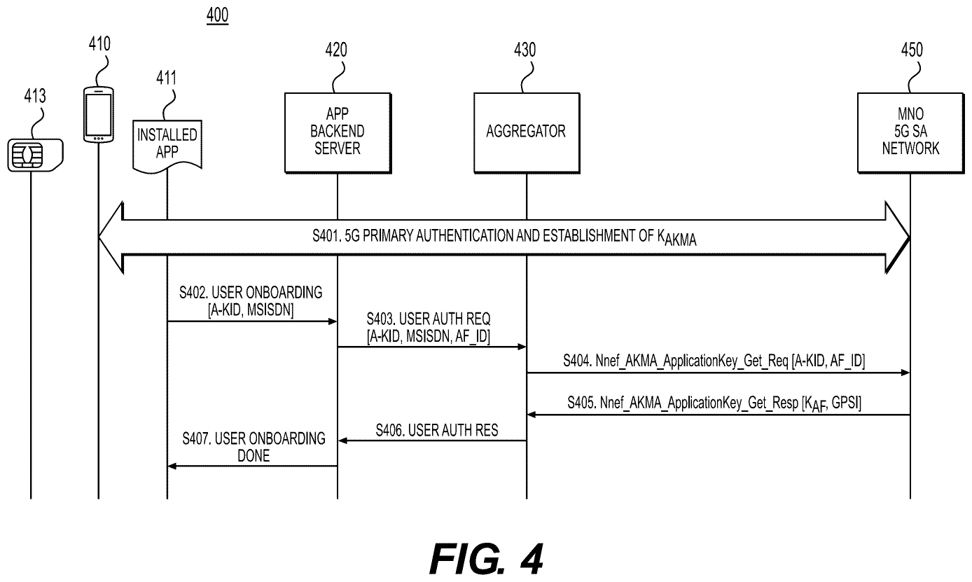

FIG. 4 depicts a SIM-based authentication process 400, according to one or more embodiments. In some aspects, the SIM-based authentication process 400 may represent an Authentication and Key Management for Applications (“AKMA”) SIM-based authentication process. As shown in FIG. 4, the SIM-based authentication process 400 may be performed using a SIM 413, a user device 410, an installed application 411, an application (or app) backend server 420, an aggregator 430, and an MNO 5G SA Network 450. In some aspects, the SIM 413 may be an embodiment of the SIM 213; the user device 410 may be an embodiment of the user device 210; the installed application 411 may be an embodiment of the application 211; the application backend server 420 may be an embodiment of the application backend server 220; the aggregator 430 may be an embodiment of the aggregator system 230; and the MNO 5G SA Network 450 may be an embodiment of the MNO network 250 in connection with the MNO Server 260 and with the signaling connection by the Signaling Carrier Provider 240.

In some aspects, the SIM-based authentication process 400 may be performed when various conditions are satisfied. For example, the SIM-based authentication process 400 may be performed when (i) a MNO that provides a mobile service on the user device 410 (e.g., the MNO 5G SA Network 450) supports 5G SA, the AKMA framework, and the Core Network support for AKMA; (ii) the user device 410 supports 5G SA and AKMA; (iii) each of the installed application 411, the application backend server 420, and the aggregator 430 is registered with the MNO 5G SA Network 450 as an AKMA application and provider; and (iv) the MNO 5G SA Network 450 supports external AKMA application and access.

As shown in FIG. 4, the SIM-based authentication process 400 may include steps S401 through S407. At S401, the user device 410 includes the SIM 413 the user device 410 is connected to a home MNO (e.g., the MNO 5G SA Network 450); and the user device 410 has completed 5G primary authentication and has established the necessary AKMA configurations. At S402, a user of the user device 410 installs a third-party application (the installed application 411), where the installed application 411 is received from an application provider (e.g., the application backend server 420). Further, the installed application 411 onboards the user to the application backend server 420 (or submits a request to reauthenticate the user) by providing the user's MSISDN and AKMA Key ID (“A-KID”) to the application backend server 420. At S403, the application backend server 420 queries the aggregator 430 (e.g., a partner aggregator) to authenticate the user with the user's home MNO (e.g., the MNO of the MNO 5G SA Network 450) by providing the user's MSISDN, A-KID, and the application provider's application function identifier (“AF_ID”). At S404, the aggregator 430 examines the A-KID to identify the user's MNO (e.g., the MNO of the MNO 5G SA Network 450), and subsequently queries the MNO 5G SA Network 450 with the HTTP/2 Nnef_AKMA_ApplicationKey_Get_Req operation with the user's A-KID and the application provider's AF_ID. At S405, the MNO 5G SA Network 450 responds with the HTTP/2 Nnef_AKMA_ApplicationKey_Get_Resp with the user's General Public Subscription Identifier (“GPSI”) and the AKMA application key (“K_{AF}”).

At S406, the aggregator 430 compares the MSISDN received from the user with a value of the GPSI received from the MNO 5G SA Network 450 and transmits the results of the comparison to the application backend server 420. For example, where the MSISDN matches the value of the GPSI, the aggregator 430 may transmit an indication of TRUE to the application backend server 420; and where the MSISDN does not match the value of the GPSI, the aggregator 430 may transmit an indication of FALSE to the application backend server 420. At S407, the application backend server 420 may process these results to determine the outcome of the user onboarding, and whether the user's AKMA SIM-based authentication is successful. If the application backend server 420 determines that the user onboarding is complete and that the user of the user device 410 is authenticated, then the user may proceed to use the installed application 411 with the verified MSISDN and SIM. In some aspects, where the application backend server 420 determines that the AKMA SIM-based authentication is successful, this represents that MSISDN is associated with the SIM 413, which is verified to be in use in the user device 410. If the application backend server 420 determines that the user onboarding is not complete and/or that the user of the user device 410 is not authenticated, then the user may not proceed to use or access one or more functions of the installed application 411 such as to use the MSISDN with the application. Further, where the application backend server 420 determines that the AKMA SIM-based authentication is unsuccessful, this represents that MSISDN is not associated with the SIM 413, and hence the MSISDN is not verified and the installed application 411 may refuse to accept the MSISDN as the user's identity in association with the SIM 413.

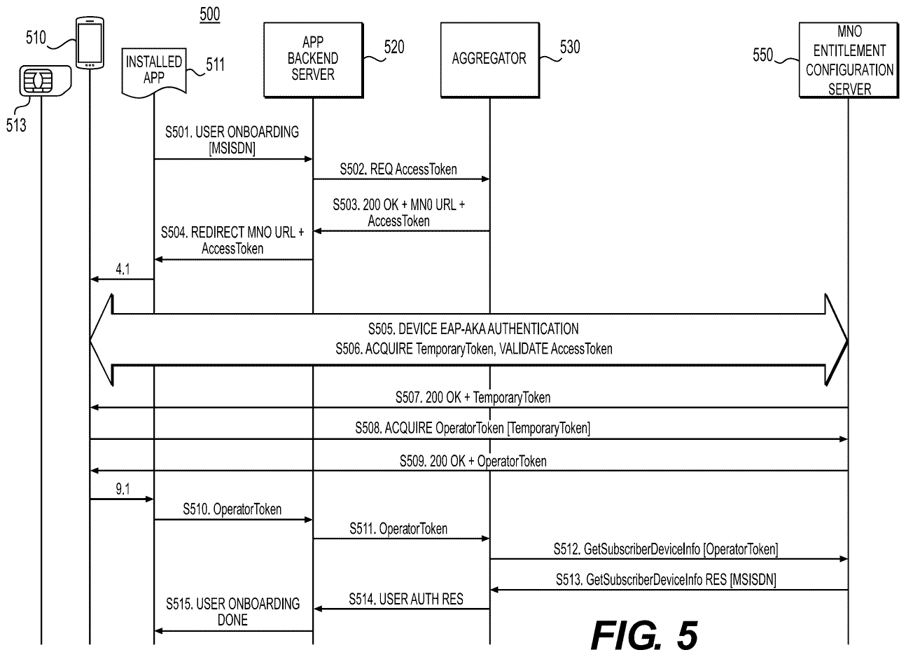

FIG. 5 depicts a SIM-based authentication process 500, according to one or more embodiments. In some aspects, the SIM-based authentication process 500 may represent a TS.43 Operator Token SIM-based authentication process. As shown in FIG. 5, the SIM-based authentication process 500 may be performed using a SIM 513, a user device 510, an installed application 511, an application (or app) backend server 520, an aggregator 530, and an MNO Entitlement Configuration Server 550. In some aspects, the SIM 513 may be an embodiment of the SIM 213; the user device 510 may be an embodiment of the user device 210; the installed application 511 may be an embodiment of the application 211; the application backend server 520 may be an embodiment of the application backend server 220; the aggregator 530 may be an embodiment of the aggregator system 230; and the MNO Entitlement Configuration Server 550 may be an embodiment of the MNO server 260 within the MNO network 250.

In some aspects, the SIM-based authentication process 500 may be performed when various conditions are satisfied. For example, the SIM-based authentication process 500 may be performed when (i) a home MNO of the user device 510 supports the MNO Entitlement Configuration Server 550 and TS.43 operations; (ii) the user device 510 supports or includes the TS.43 client (e.g., the client 212); (iii) the installed application 511 possesses a privilege to access the TS.43 client on the user device 510; and (iv) the aggregator 530 is integrated with flows or operations of the MNO Entitlement Configuration Server 550 and TS.43.

As shown in FIG. 5, the SIM-based authentication process 500 may include steps S501 through S515. At S501, the user device 510 includes the SIM 513; the user device 510 supports or includes the TS.43 client and operations associated with the operating system of the user device 510; the user device 510 is connected to the MNO Entitlement Configuration Server 550 (or an MNO Core Network such as the MNO network 250); the user installs a third-party application (the installed application 511) on the user device 510, where the third-party application is received from an application provider; and the installed application 511 onboards the user onto (or requests reauthentication of the user by) the application backend server 520 by providing the user's MSISDN to the application backend server 520. At S502, the application backend server 520 queries the aggregator 530 (e.g., a partner aggregator) for an Access Token, and provides the user's MSISDN to the aggregator 530. At S503, the aggregator 530 looks up the user's MNO (e.g. a home MNO) based on the received MSISDN, and generates the Access Token for the application backend server 520, in relation to some pre-configurations and exchanges with the MNO Entitlement Configuration Server 550. The aggregator 530 subsequently responds to the application backend server 520 with the MNO's Entitlement Configuration Server 550 uniform resource locator (“URL”) and the Access Token. At S504 and S504.1, the application backend server 520 responds to the installed application 511 to redirect the TS.43 client of the user device 510 with the URL of the MNO Entitlement Configuration Server 550 and the Access Token. At S505, the TS.43 client of the user device 510 triggers the device EAP-AKA authentication with the MNO Entitlement Configuration Server 550, based on the received URL of the MNO Entitlement Configuration Server 550. At S506, when the EAP-AKA authentication is successful, the TS.43 client of the user device 510 requests a Temporary Token from the MNO Entitlement Configuration Server 550, and requests that the MNO Entitlement Configuration Server 550 validate the Access Token. At S507, when the Access Token has been successfully validated, the MNO Entitlement Configuration Server 550 provides the TS.43 client of the user device 510 with the Temporary Token. At S508, the TS.43 client of the user device 510 requests an Operator Token from the MNO Entitlement Configuration Server 550 with the Temporary Token. At S509, when the MNO Entitlement Configuration Server 550 successfully validates the Temporary Token, the MNO Entitlement Configuration Server 550 generates the Operator Token and provides the Operator Token to the TS.43 client. At S509.1, the TS.43 client provides the Operator Token to the installed application 511. At S510, the installed application 511 provides the received Operator Token to the application backend server 520. At S511, the application backend server 520 provides the Operator Token to the aggregator 530. At S512, the aggregator 530 uses the Operator Token and the GetSubscriberDeviceInfo operation to query the MNO Entitlement Configuration Server 550. At S513, the MNO Entitlement Configuration Server 550 validates the Operator Token, and upon the successful validation, carries out the GetSubscriberDeviceInfo operation, obtains the user's MSISDN, and provides the user's MSISDN to the aggregator 530. At S514, the aggregator 530 compares the MSISDN value received from the MNO Entitlement Configuration Server 550 to the MSISDN received from the installed application 511, and transmits the results of the comparison (e.g., TRUE where the MSISDN values match, or FALSE where the MSISDN values do not match) to the application backend server 520. At S515, the application backend server 520 processes these results to determine the outcome of the user's onboarding, and whether the SIM-based authentication is successful.

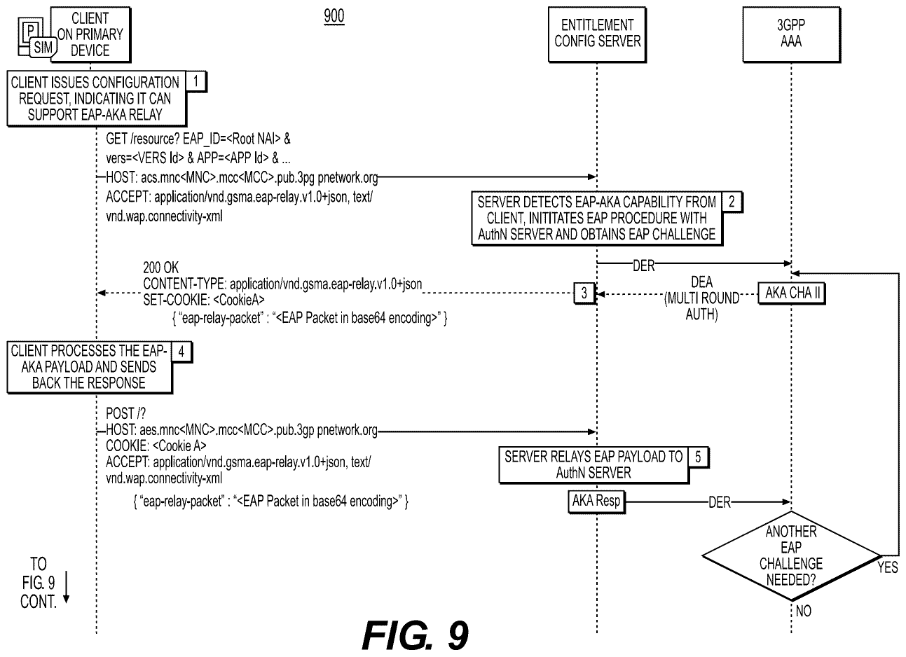

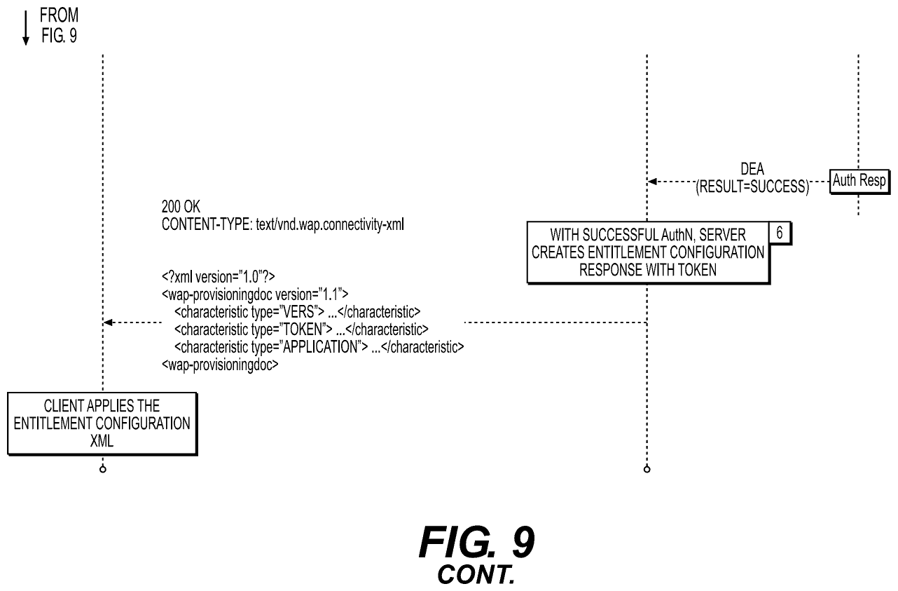

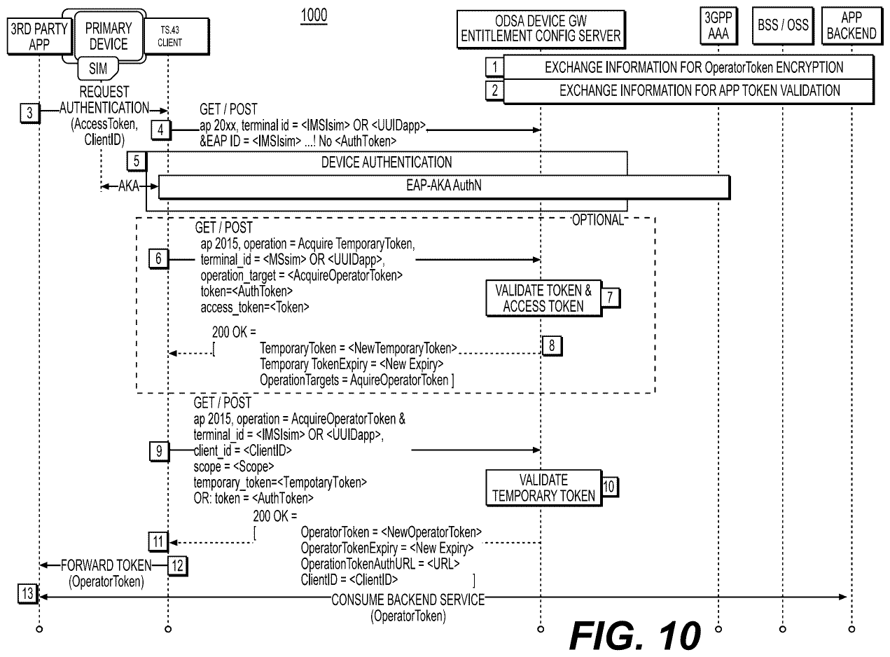

In some aspects, the SIM-based authentication process 500 of FIG. 5 is associated with various procedures and features of the TS.43 Technical Specification. For example, as shown in FIG. 9, the TS.43 Technical Specification describes the authentication mechanism 900, HTTP Embedded EAP-AKA Authentication by Entitlement Configuration Server. As shown in FIG. 10, the TS.43 Technical Specification describes a process 1000 representing a device application authentication with Operator Token, which may involve the GetSubscriberDeviceInfo operation and MSISDN/IMSI. As shown in FIG. 11, the TS.43 Technical Specification describes a process 1100 representing an example Operator Token GetSubscriberDeviceInfo operation flow.

In some aspects, the specification, GSMA PRD Authorization Server Authenticator Capacities (“ASAC”) .01 (e.g., GSMA PRD ASAC.01), describes enhancements to TS.43 that facilitate seamless authentication of MSISDN over Wi-Fi with third-party application support. In some aspects, an ASAC subgroup of GSMA prepared this document to (i) extend the seamless authentication of MSISDN to Wi-Fi (in addition to packet data), and (ii) support authentication using third party applications (other than carrier privileged applications). The GSMA PRD ASAC.01 specification leverages the SIM-based EAP-AKA authentication described in the TS.43 Technical Specification. ASAC.01 proposed that the device Operating System expose an operation system API to applications and browsers to trigger the MSISDN seamless authentication. Accordingly, this will extend the third-party application access to the TS.43 client beyond the operating system and carrier privileged applications. Thus, there will be a dependency on the operating system vendors to support this capability in their operating system releases.

In some aspects, the SIM-based authentication methods described herein may be used for a variety of applications. For example, the SIM-based authentication methods may be used to prove that a user is in possession of a SIM (or a user device that includes a SIM) for two-factor authentication, multi-factor authentication, or to comply with a level of assurance. Further, the SIM-based authentication method 500 described herein may be used to extend Number Verification solution over Wi-Fi and packet-switched transmission (or for packet data access) for seamless MSISDN authentication. This may leverage the GSMA PRD ASAC.01 specification for third-party applications to access the Operator Token flow via the TS.43 client, provided operating system API support for this capability is available.

Further, the Operator Token flow for device application authentication described in FIG. 10 may support SIM-based authentication for third-party applications in order to securely validate the SIM associated with a third-party application or other application installed on a user device. This effectively replaces the OTP that may be provided to SIM-based devices using channels such as SMS, RCS, OTT, TTS, or FC, for user authentication, and ensures that a SIM is included in a mobile device of a user being authenticated (e.g., ensure that the user is in possession of the SIM).

With reference to FIG. 11, the acquisition of the Operator Token to carry out the GetSubscriberDeviceInfo operation may facilitate a network-based authentication procedure. This may be used as an alternative to an IP-to-MSISDN mapping method that depends on packet data access only.

Further, based on the SIM-based authentication methods described herein, it is expected that routing by an aggregator of an enterprise or client's ECS-related queries or requests to an MNO's ECS following the aggregator deployment of the MNO lookup mechanism described herein, will become prominent.

Further, based on GSMA PRD ASAC.01 and the SIM-based authentication methods described herein, a SIM card may be used as a universal possession factor in Identity Wallets such as for the European Union's Digital Identity (EUDI) wallet, as part of eIDAS 2.0. In addition, based on GSMA PRD ASAC.01 and the SIM-based authentication method 500 described herein, a TS.43 Access Token may be generated for third-party application access to an Operator Token.

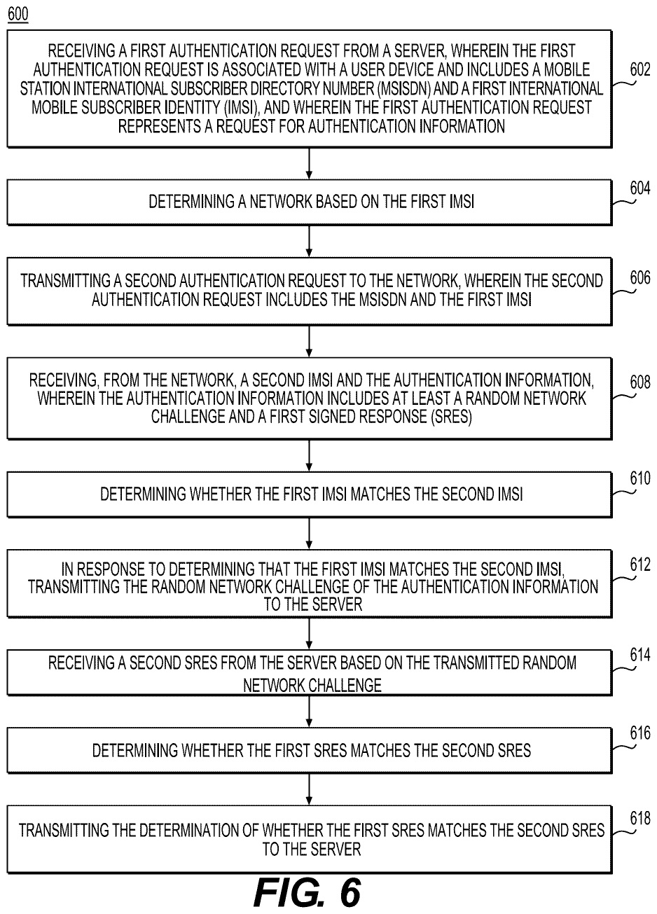

FIG. 6 depicts a flow diagram of a method 600 for SIM-based authentication, according to one or more embodiments. In some aspects, the method 600 may be performed by the aggregator 330. Further, the method 600 may represent a portion of the MAP SAI SIM-based authentication method of FIG. 3.

As shown in FIG. 6, the method 600 may include receiving, by a computing system, a first authentication request from a server, where the first authentication request is associated with a user device and includes a Mobile Station International Subscriber Directory Number (“MSISDN”) and a first International Mobile Subscriber Identity (“IMSI”), and where the first authentication request represents a request for authentication information (602). In some aspects, the computing system may include an API gateway configured to communicate with the server.

The method 600 may include determining, by the computing system, a network based on the first IMSI (604). The method 600 may include transmitting, by the computing system, a second authentication request to the network, wherein the second authentication request includes the MSISDN and the first IMSI (606). The method 600 may include receiving, by the computing system and from the network, a second IMSI and the authentication information, wherein the authentication information includes at least a random network challenge (“RAND”) and a first Signed Response (SRES) (608). In some aspects, the authentication information may further include a Ciphering Key (K_{c}).

The method 600 may include determining, by the computing system, whether the first IMSI matches the second IMSI (610). The method 600 may include, in response to determining that the first IMSI matches the second IMSI, transmitting, by the computing system, the random network challenge of the authentication information to the server (612). The method 600 may include receiving, by the computing system, a second SRES from the server based on the transmitted random network challenge (614).

The method 600 may include determining, by the computing system, whether the first SRES matches the second SRES (616). In some aspects, a determination that the first SRES matches the second SRES represents that the first IMSI is stored in a SIM internal to the user device and is associated with the provided MSISDN. Further, a determination that the first SRES does not match the second SRES represents that the first IMSI stored in a SIM internal to the user device is not associated with the provided MSISDN. The method 600 may include transmitting, by the computing system, the determination of whether the first SRES matches the second SRES to the server (618).

In some embodiments, the computing system may include a transformation function module configured to associate the first authentication request with the second authentication request. Further, the computing system may include an exposure function module configured to communicate with the network. In some aspects, the computing system may be configured to access the network using signaling.

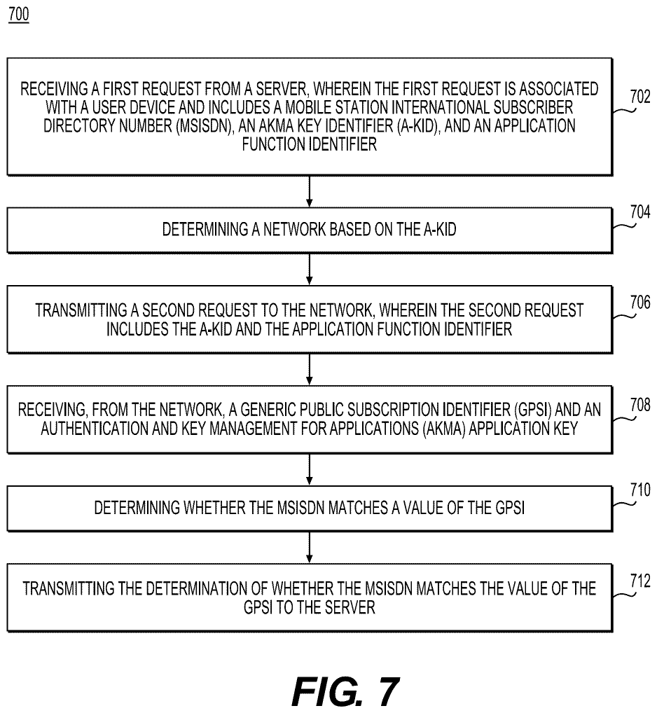

FIG. 7 depicts a flow diagram of a method 700 for SIM-based authentication, according to one or more embodiments. In some aspects, the method 700 may be performed by the aggregator 430. Further, the method 700 may represent a portion of the AKMA SIM-based authentication method of FIG. 4.

As shown in FIG. 7, the method 700 may include receiving, by a computing system, a first request from a server, wherein the first request is associated with a user device and includes a Mobile Station International Subscriber Directory Number (“MSISDN”), an AKMA Key Identifier (“A-KID”), and an Application Function Identifier (702). In some aspects, the computing system may include an API gateway configured to communicate with the server. The method 700 may include determining, by the computing system, a network based on the A-KID (704). The method 700 may include transmitting, by the computing system, a second request to the network, wherein the second request includes the A-KID and the Application Function Identifier (706).

The method 700 may include receiving, by the computing system and from the network, a Generic Public Subscription Identifier (“GPSI”) and an Authentication and Key Management for Applications (“AKMA”) application key (708). The method 700 may include determining, by the computing system, whether the MSISDN matches a value of the GPSI (710). In some aspects, a determination that the MSISDN matches the value of the GPSI represents that the MSISDN is associated with a SIM internal to the user device. Further, in some aspects, a determination that the MSISDN does not match the value of the GPSI represents that the MSISDN is not associated with a SIM internal to the user device. The method 700 may also include transmitting, by the computing system, the determination of whether the MSISDN matches the value of the GPSI to the server (712).

In some embodiments, the computing system may include a transformation function module configured to associate the first request with the second request. Further, the computing system may include an exposure function module configured to communicate with the network. In some aspects, the computing system may be configured to access the network using signaling.

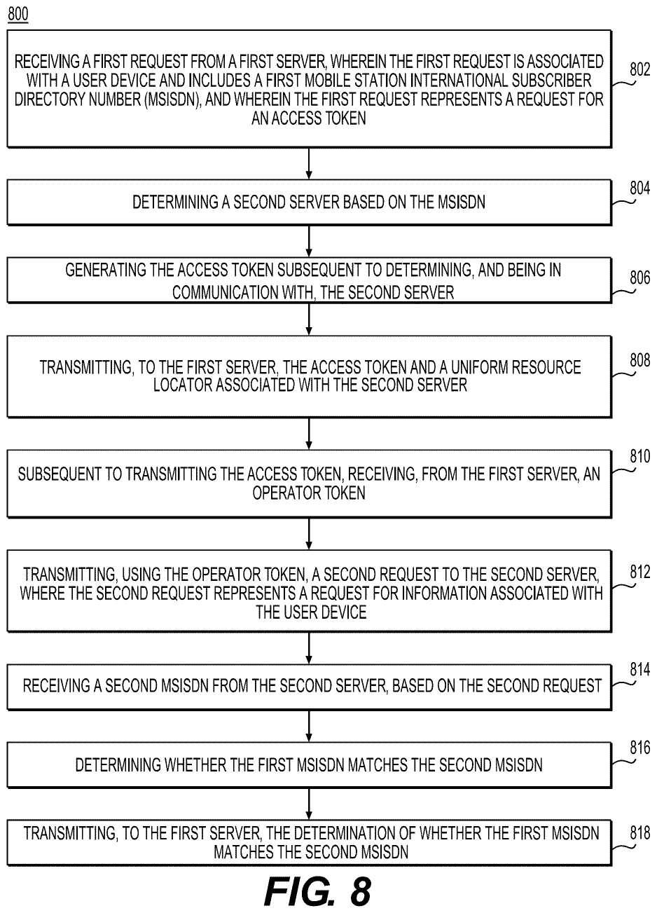

FIG. 8 depicts a flow diagram of a method 800 for SIM-based authentication, according to one or more embodiments. In some aspects, the method 800 may be performed by the aggregator 530. Further, the method 800 may represent a portion of the TS.43 Operator Token SIM-based authentication method of FIG. 5.

As shown in FIG. 8, the method 800 may include receiving, by a computing system, a first request from a first server, wherein the first request is associated with a user device and includes a first Mobile Station International Subscriber Directory Number (“MSISDN”), and wherein the first request represents a request for an Access Token (802). The method 800 may include determining, by the computing system, a second server based on the MSISDN (804).

The method 800 may include generating, by the computing system, the Access Token subsequent to determining (and being in communication with) the second server (806). The method 800 may include transmitting, by the computing system and to the first server, the Access Token and a uniform resource locator associated with the second server (808). The method 800 may include, subsequent to transmitting the Access Token, receiving, by the computing system and from the first server, an Operator Token (810). The method 800 may include transmitting, by the computing system and using the Operator Token, a second request to the second server, wherein the second request represents a request for information associated with the user device (812).

The method 800 may include receiving, by the computing system, a second MSISDN from the second server, based on the second request (814). The method 800 may include determining, by the computing system, whether the first MSISDN matches the second MSISDN (816). In some aspects, a determination that the first MSISDN matches the second MSIDN represents that the first MSISDN is associated with a SIM internal to the user device. Further, in some aspects, a determination that the first MSISDN does not match the second MSISDN represents that the first MSISDN is not associated with a SIM internal to the user device.

The method 800 may include transmitting, by the computing system and to the first server, the determination of whether the first MSISDN matches the second MSISDN (818). In some embodiments, the computing system may include an API gateway configured to communicate with the first server. Further, the computing system may include a transformation function module configured to associate the first request with the second request. In some embodiments, the computing system may include an exposure function module configured to communicate with the second server.

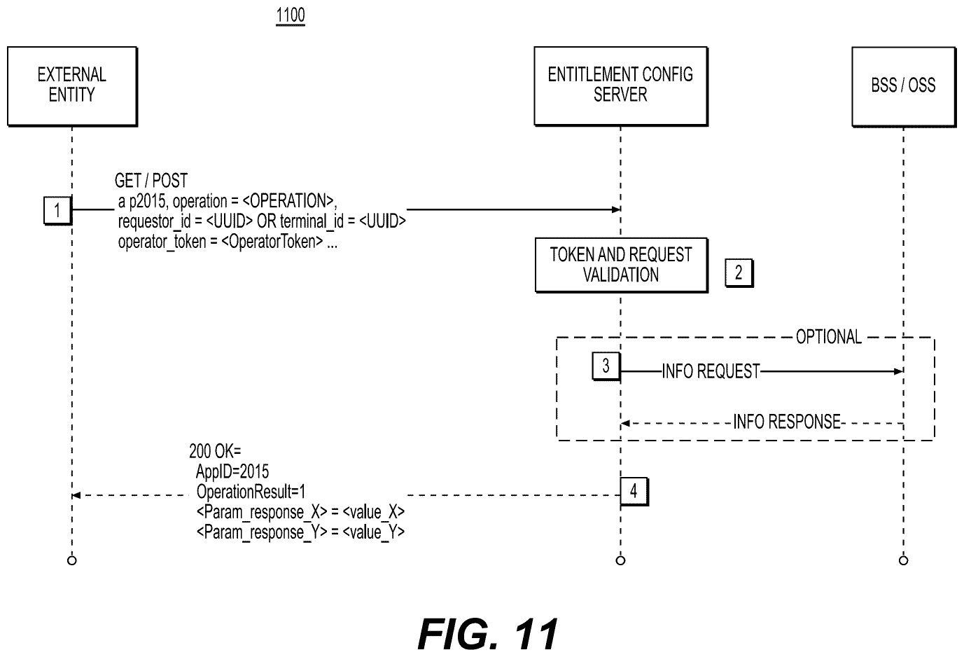

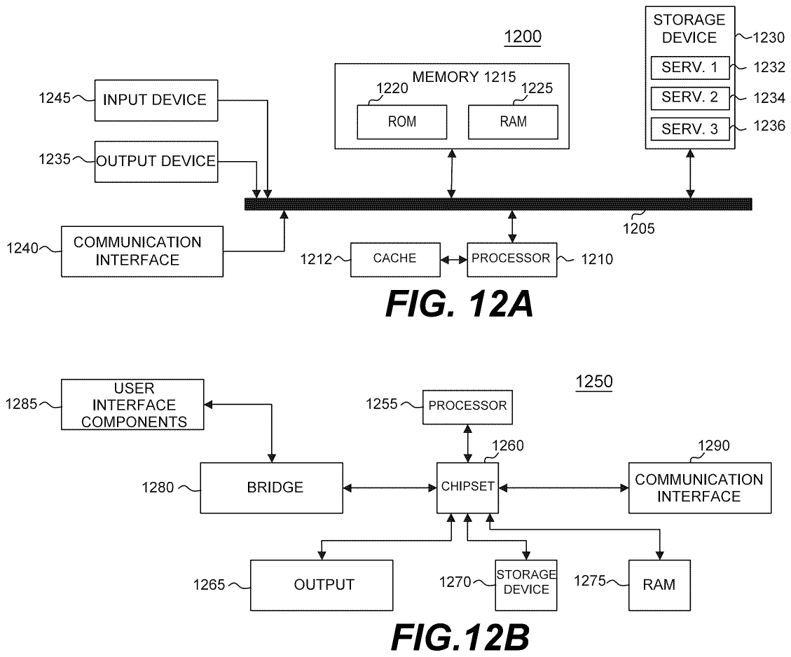

FIG. 12A illustrates an architecture of computing system 1200, according to example embodiments. The computing system 1200 (also referred to herein as a “system 1200”) may be representative of at least a portion of the user device 210, the application backend server 220, the aggregator system 230, or another system or device of the computing environment 200. One or more components of computing system 1200 may be in electrical communication with each other using a bus 1205. System 1200 may include a processing unit (CPU or processor) 1210 and a system bus 1205 that couples various system components including the system memory 1215, such as read only memory (ROM) 1220 and random access memory (RAM) 1225, to processor 1210. System 1200 may include a cache of high-speed memory connected directly with, in close proximity to, or integrated as part of processor 1210. System 1200 may copy data from memory 1215 and/or storage device 1230 to cache 1212 for quick access by processor 1210. In this way, cache 1212 may provide a performance boost that avoids processor 1210 delays while waiting for data. These and other modules may control or be configured to control processor 1210 to perform various actions. Other system memory 1215 may be available for use as well. Memory 1215 may include multiple different types of memory with different performance characteristics. Processor 1210 may include any general purpose processor and a hardware module or software module, such as service 1 1232, service 2 1234, and service 3 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction with the computing system 1200, an input device 1245 may represent any number of input mechanisms, such as a microphone for speech, a touch-sensitive screen for gesture or graphical input, keyboard, mouse, motion input, speech and so forth. An output device 1235 (e.g., display) may also be one or more of a number of output mechanisms known to those of skill in the art. In some instances, multimodal systems may enable a user to provide multiple types of input to communicate with computing system 1200. Communications interface 1240 may generally govern and manage the user input and system output. There is no restriction on operating on any particular hardware arrangement and therefore the basic features here may easily be substituted for improved hardware or firmware arrangements as they are developed.

Storage device 1230 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 1225, read only memory (ROM) 1220, and hybrids thereof.

Storage device 1230 may include services 1232, 1234, and 1236 for controlling the processor 1210. Other hardware or software modules are contemplated. Storage device 1230 may be connected to system bus 1205. In one aspect, a hardware module that performs a particular function may include the software component stored in a computer-readable medium in connection with the necessary hardware components, such as processor 1210, bus 1205, output device 1235, and so forth, to carry out the function.

FIG. 12B illustrates a computer system 1250 having a chipset architecture that may represent at least a portion of the user device 210, the application backend server 220, the aggregator system 230, or another system or device of the computing environment 200. Computer system 1250 may be an example of computer hardware, software, and firmware that may be used to implement the disclosed technology. System 1250 may include a processor 1255, representative of any number of physically and/or logically distinct resources capable of executing software, firmware, and hardware configured to perform identified computations. Processor 1255 may communicate with a chipset 1260 that may control input to and output from processor 1255. In this example, chipset 1260 outputs information to output 1265, such as a display, and may read and write information to storage device 1270, which may include magnetic media, and solid-state media, for example. Chipset 1260 may also read data from and write data to RAM 1275. A bridge 1280 for interfacing with a variety of user interface components 1285 may be provided for interfacing with chipset 860. Such user interface components 1285 may include a keyboard, a microphone, touch detection and processing circuitry, a pointing device, such as a mouse, and so on. In general, inputs to system 1250 may come from any of a variety of sources, machine generated and/or human generated.

Chipset 1260 may also interface with one or more communication interfaces 1290 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 1255 analyzing data stored in storage device 1270 or RAM 1275. Further, the machine may receive inputs from a user through user interface components 1285 and execute appropriate functions, such as browsing functions by interpreting these inputs using processor 1255.

It may be appreciated that example systems 1200 and 1250 may have more than one processor 1210 or be part of a group or cluster of computing devices networked together to provide greater processing capability. Further, the example systems 1200 and 1250 may be applicable to a cloud-based solution; hosted in one or more data centers; or associated with or included in a virtual system (e.g., be based on a virtual machine or software container implementation).

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings

What is claimed is:

1. A method comprising:
receiving, by a computing system, a first authentication request from a server, wherein the first authentication request is associated with a user device and includes a Mobile Station International Subscriber Directory Number (MSISDN) and a first International Mobile Subscriber Identity (IMSI), and wherein the first authentication request represents a request for authentication information;
determining, by the computing system, a network based on the first IMSI;
transmitting, by the computing system, a second authentication request to the network, wherein the second authentication request includes the MSISDN and the first IMSI;
receiving, by the computing system and from the network, a second IMSI and the authentication information, wherein the authentication information includes at least a random network challenge and a first Signed Response (SRES);
determining, by the computing system, whether the first IMSI matches the second IMSI;
in response to determining that the first IMSI matches the second IMSI, transmitting, by the computing system, the random network challenge of the authentication information to the server;
receiving, by the computing system, a second SRES from the server based on the transmitted random network challenge;
determining, by the computing system, whether the first SRES matches the second SRES; and
transmitting, by the computing system, the determination of whether the first SRES matches the second SRES to the server.

2. The method of claim 1, wherein a determination that the first SRES matches the second SRES represents that the MSISDN being authenticated is associated with the first IMSI stored in a Subscriber Identity Module (SIM) internal to the user device.

3. The method of claim 1, wherein a determination that the first SRES does not match the second SRES represents that the MSISDN being authenticated is not associated with the first IMSI stored in a Subscriber Identity Module (SIM) internal to the user device.

4. The method of claim 1, wherein the computing system includes an application programming interface (API) gateway configured to communicate with the server.

5. The method of claim 1, wherein the computing system includes a transformation function module configured to associate the first authentication request with the second authentication request.

6. The method of claim 1, wherein the computing system includes an exposure function module configured to communicate with the network.

7. The method of claim 1, wherein the computing system is configured to access the network using signaling.

8. A method comprising:
receiving, by a computing system, a first request from a server, wherein the first request is associated with a user device and includes a Mobile Station International Subscriber Directory Number (MSISDN), an AKMA Key Identifier (A-KID), and an Application Function Identifier;
determining, by the computing system, a network based on the A-KID;
transmitting, by the computing system, a second request to the network, wherein the second request includes the A-KID and the Application Function Identifier;
receiving, by the computing system and from the network, a Generic Public Subscription Identifier (GPSI) and an Authentication and Key Management for Applications (AKMA) application key;
determining, by the computing system, whether the MSISDN matches a value of the GPSI; and
transmitting, by the computing system, the determination of whether the MSISDN matches the value of the GPSI to the server.

9. The method of claim 8, wherein a determination that the MSISDN matches the value of the GPSI represents that the MSISDN being authenticated is associated with a Subscriber Identity Module (SIM) internal to the user device.

10. The method of claim 8, wherein a determination that the MSISDN does not match the value of the GPSI represents that the MSISDN being authenticated is not associated with a Subscriber Identity Module (SIM) internal to the user device.

11. The method of claim 8, wherein the computing system includes an application programming interface (API) gateway configured to communicate with the server.

12. The method of claim 8, wherein the computing system includes a transformation function module configured to associate the first request with the second request.

13. The method of claim 8, wherein the computing system includes an exposure function module configured to communicate with the network.

14. The method of claim 8, wherein the computing system is configured to access the network using signaling.

15. A method comprising:
receiving, by a computing system, a first request from a first server, wherein the first request is associated with a user device and includes a first Mobile Station International Subscriber Directory Number (MSISDN), and wherein the first request represents a request for an Access Token;
determining, by the computing system, a second server based on the MSISDN;
generating, by the computing system, the Access Token subsequent to determining, and being in communication with, the second server;
transmitting, by the computing system and to the first server, the Access Token and a uniform resource locator associated with the second server;
subsequent to transmitting the Access Token, receiving, by the computing system and from the first server, an Operator Token;
transmitting, by the computing system and using the Operator Token, a second request to the second server, wherein the second request represents a request for information associated with the user device;
receiving, by the computing system, a second MSISDN from the second server, based on the second request;
determining, by the computing system, whether the first MSISDN matches the second MSISDN; and
transmitting, by the computing system and to the first server, the determination of whether the first MSISDN matches the second MSISDN.

16. The method of claim 15, wherein a determination that the first MSISDN matches the second MSISDN represents that the first MSISDN being authenticated is associated with a Subscriber Identity Module (SIM) internal to the user device.

17. The method of claim 15, wherein a determination that the first MSISDN does not match the second MSISDN represents that the first MSISDN being authenticated is not associated with a Subscriber Identity Module (SIM) internal to the user device.

18. The method of claim 15, wherein the computing system includes an application programming interface (API) gateway configured to communicate with the first server.

19. The method of claim 15, wherein the computing system includes a transformation function module configured to associate the first request with the second request.

20. The method of claim 15, wherein the computing system includes an exposure function module configured to communicate with the second server.
